(19) United States
(12) Patent Application Publication
(10) Pub. No.: US 2014/0131471 A1
(43) Pub. Date: May 15, 2014

(54) Apparatus to channel large air masses for climate modification

(71) Applicant: Douglas McArthur Hatch, Running Springs, CA (US)

(72) Inventor: Douglas McArthur Hatch, Running Springs, CA (US)

(21) Appl. No.: 14/050,164

(22) Filed: Oct. 9, 2013

Related U.S. Application Data
(60) Provisional application No. 61/712,258, filed on Oct. 11, 2012.

(51) Int. Cl. A01G 15/00

(52) U.S. Cl. CPC A01G 15/00
USPC 239/14.1

(57) ABSTRACT

A method for modifying the weather by channeling dry air masses over large bodies of water by means of an artificial barrier built at an acute angle as to the incoming dry air mass that comprises a low air resistance belt to channel air movement and a high resistance belt to deflect incoming dry air into the low air resistance belt that terminates at a large body of water. Once over a large body of water the dry air mass will readily collect moisture released by the large body of water by evaporation and then be taken by prevailing trade winds over land where the moisture will be deposited in the form of rain.

### CROSS-REFERENCE TO RELATED APPLICATIONS

This application claims the benefit of U.S. Provisional Application No. 61/712,258, filed Oct. 11, 2012, which is incorporated herein by reference in its entirety.

In addition this application references the following U.S. patents:

U.S. Pat. No. 3,568,925 filed August 1968 by Lietzer.

U.S. Pat. No. 4,600,147 filed July 1983 by Fukuta, et al.

U.S. Pat. No. 4,653,690 filed November 1984 by St. Amand, et al.

U.S. Pat. No. 5,174,498 filed January 1991 by Popovitz-Biro, et al.

U.S. Pat. No. 5,492,274 filed May 1994 by Assaf, et al.

U.S. Pat. No. 8,439,278 PCT filed March 2009 by Murakami, et al.

### BACKGROUND OF THE INVENTION

1. Field of the Invention

The invention relates to an apparatus for the modification of climate conditions by deflecting large volumes of dry air into a channel that leads to a large body of water wherein said dry air readily absorbs moisture released evaporatively by said large body of water. Natural winds prevalent over said large body of water will eventually push the now moisture rich said air over land where the moisture will be deposited in the form of rain.

2. Description of Related Art

As portions of our planet are stricken by long periods of drought or when it is desirable to transform desert regions to be capable of supporting farming operations inventors have sought ideas related to altering climate conditions so as to encourage the creation of rain bearing clouds. This can be seen by the many patents that have been applied for in the field of weather modification, specifically for the purposes of artificially producing rainfall.

One method for altering climate conditions so as to encourage the creation of rain bearing clouds is to introduce into existing cloud formations various compounds for that purpose. These compounds include silver iodide, dry ice, or other materials. U.S. Pat. No. 4,600,147 proposes using liquid propane based compound that is inserted into the cloud via a rocket. The Popovitz-Biro patent, U.S. Pat. No. 5,174,498, proposes seeding clouds with a long chain aliphatic alcohols which are biodegradable and inexpensive. However these methods requires that certain classes of clouds be present as the compounds do require some amount of water to be present. In addition there are problems with delivery of the compounds into the clouds. The insertion of these compounds into the wrong portion of an ever moving cloud or inserting the wrong amount into the correct portion of the cloud will result in failure. Falling debris from a spent rocket could damage property or injure people. Finally some of the compounds, such as those that use silver, may have an adverse ecological effect.

Thermal inversion layers may also create climate conditions that prevent the creation of rain bearing clouds. During an inversion episode, temperatures increases with increasing altitude. The warm inversion layer then acts as a cap over the colder air masses and stops vertical atmospheric mixing that is necessary to create rain bearing clouds. U.S. Pat. No. 4,653,690 proposes pyrotechnic scheme containing an alkali earth metal. The heat of the protechnics along with the alkali would disrupt the inversion layer to allow vertical movement of air. This vertical movement of air will aid in the creation of rain bearing cumulonimbus or cumulus clouds. The major problem stemming from this approach is the prerequisite that an inversion layer be present. Land areas that require a certain and regular rainfall, such as farming areas, may not be located in an area where inversion layers are formed.

A final method for altering climate conditions so as to encourage the creation of rain bearing clouds is to stimulate the process of evaporation of oceanic water. This method was disclosed by the Lietzer patent; U.S. Pat. No. 3,568,925. Lietzer sought to create rain bearing clouds by increasing the evaporation rate of ocean water by spreading a solar radiation absorbing material over large coastal oceanic areas close to land. Although this method has the potential to affect climate on a macro level the solar radiation absorbing material proposed by Lietzer involves the use of carbon that is carried by smoke created by burning a petroleum product at sea. Although this method would facilitate the movement of water into the atmosphere it would be at the expense of polluting the ocean water and the air. A similar idea was disclosed by the Murakami patent: U.S. Pat. No. 8,439,278. Murakami proposed the deployment of large sheets of a thin film over oceanic water. The film has attributes that would allow water to be absorbed from below the film while radiation is absorbed above the film. The radiation would heat the film resulting in evaporating the absorbed water. This proposal also has problems. The film will move along with ocean current, must survive ever present oceanic storms, and may be rendered inoperable by salt deposits that remain after the water is absorbed.

The present invention may operate at a macro level, changing the atmospheric conditions over large land masses; does not introduce any chemical compositions that would foul the Earth's air, water, or land resources; and finally, as an additional benefit, provide a large renewable source of energy. The prior art have serious disadvantages such as requiring the existence of clouds, use of polluting elements and pyrotechnics, and covering oceans with large sheets of film that are overcome by the present invention.

### BRIEF SUMMARY OF THE INVENTION

The movement of large air masses, winds, is the most significant contributor of climate change. The air above the earth's surface is in a constant state of flux. The movement of air creates vast areas on the earth's surface of high and low pressure. Air in high pressure area moves into areas of low pressure. This movement creates “fronts” of either cold or hot air and many times it is at these “fronts” where the larger stratus and cumulus clouds capable of carry water are formed.

In view of the above-mentioned problems in the conventional art, it is an object of the present invention to provide an apparatus for deflecting the natural movement of large masses of dry air from its normal course to a course that will take the dry air mass over an oceanic water source. Once the dry air mass is moved over an oceanic water source moisture released by the evaporation process will be readily collected by the dry air mass leading to cloud formations. These cloud formations will then be taken by prevailing trade winds over land where the collected moisture will be deposited as rain.

The apparatus to deflect the dry air mass is to be constructed in a location where regular movement of dry air masses is prevalent and be proximately located to an oceanic water source. The apparatus is to be constructed at an angle to the oncoming dry air mass so as to maximize the amount of air that is deflected and provide a means of channeling the movement of the dry air mass towards the oceanic water source. An optimal location for the present invention is in the plains of northern Canada to deflect dry air masses moving south from the Arctic region westward towards the Pacific Ocean. Other locations exist on the planet and the present invention may be easily scaled up or down to meet the desired amount of air deflection.

The present invention will consist of two belts as seen by the oncoming dry air mass. The two belts rely on the principles of fluid dynamics in that high air resistant belt working in tandem with a low air resistant belt will maximize the volume of deflected air.

The first belt as seen by the oncoming air mass will be a corridor that is free of obstructions. The corridor is to be of sufficient width to allow the planned for volume of air to move within it, at the proper angle so as to maximize the volume of deflected air, and long enough to provide a path for the oncoming air directly to the oceanic water source.

The second belt as seen by the oncoming air mass will be a large array of closely packed wind turbines so arranged to maximize the resistance to the oncoming air mass. The resisting action of the wind turbines may be converted into electrical energy as an added benefit of this apparatus. When the oncoming air mass encounters this resisting belt principles of fluid dynamics will require that the air mass seek another path of lower resistance if such a path exists. The corridor of the first belt that is free of obstructions will be that path of lower resistance. The oncoming air mass will be deflected onto the first belt and so be taken to the oceanic water source.

### BRIEF DESCRIPTION OF DRAWINGS

The objects, features and advantages of the present invention will be apparent to one skilled in the art from reading the following detailed description in which:

FIG. 1 is a perspective view of a windbreak to demonstrate the principles of fluid dynamics utilized by the present invention.

FIG. 2 is a top view of the present invention.

FIG. 3 shows the life cycle of dry air masses channeled by the present invention to an oceanic water source that is then carried by prevailing trade winds over land.

FIG. 4 is a perspective view of the present invention for channeling airflow.

FIG. 5 shows an alternate embodiment that includes additional devices to impede the flow of air in the resistance belt.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

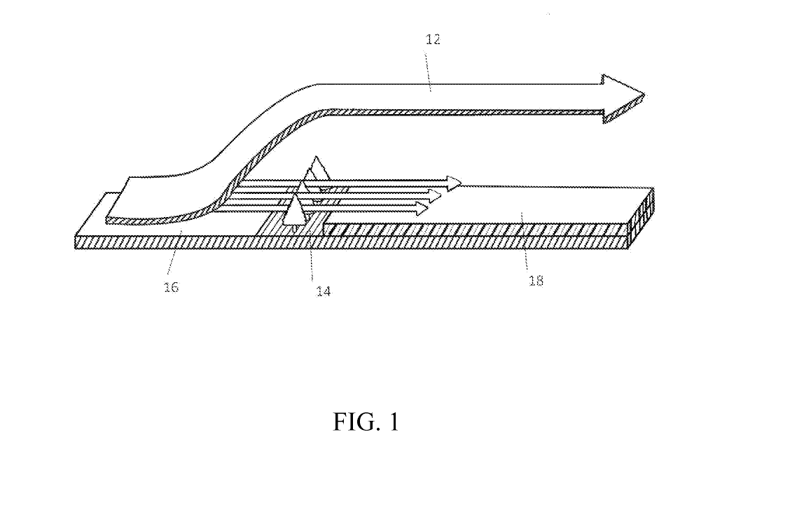

Windbreaks gives an example of the principle of fluid dynamics that holds that fluids always flow by the path of least resistance. Windbreaks refers to growing trees and/or tall crops perpendicular to the direction of prevailing wind to reduce the wind velocity and create a favourable microclimate for farming on the side opposite the prevailing wind. FIG. 1 shows a perspective view of a windbreak that is commonly used by farmers. In the center is windbreak 14 and it lies perpendicular to prevailing wind 12 blowing from left to right. Exposed land 16 that precedes windbreak 14 receives no benefits from windbreak 14. Crops and other vegetation in exposed land 16 are susceptible to a number of unfavorable factors such as aridness, greater wind chill, and soil erosion and suffer structural damage when prevailing wind 12 is present with sufficient velocities. Protected land 18 that follows windbreak 14 is protected from these adverse effects as prevailing wind 12, following the principle of fluid dynamics in that fluids always flow by the path of least resistance, is for the most part deflected upward by windbreak 14 so that it passes over protected land 18. Although FIG. 1 is useful to demonstrate the principle that fluids always flow by the path of least resistance it is not a disclosure of the present invention.

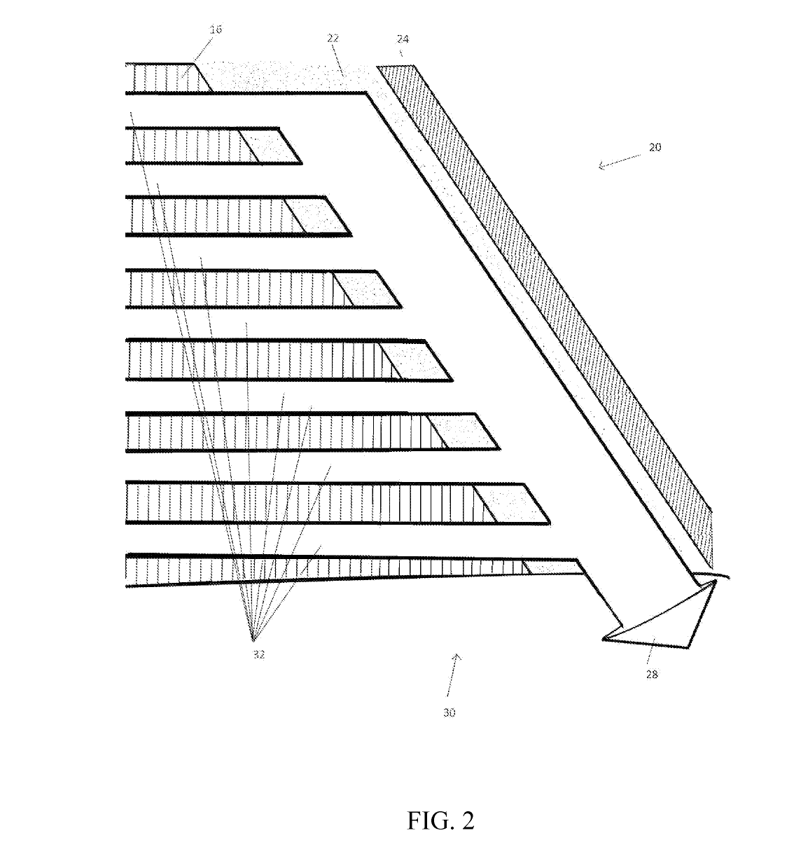

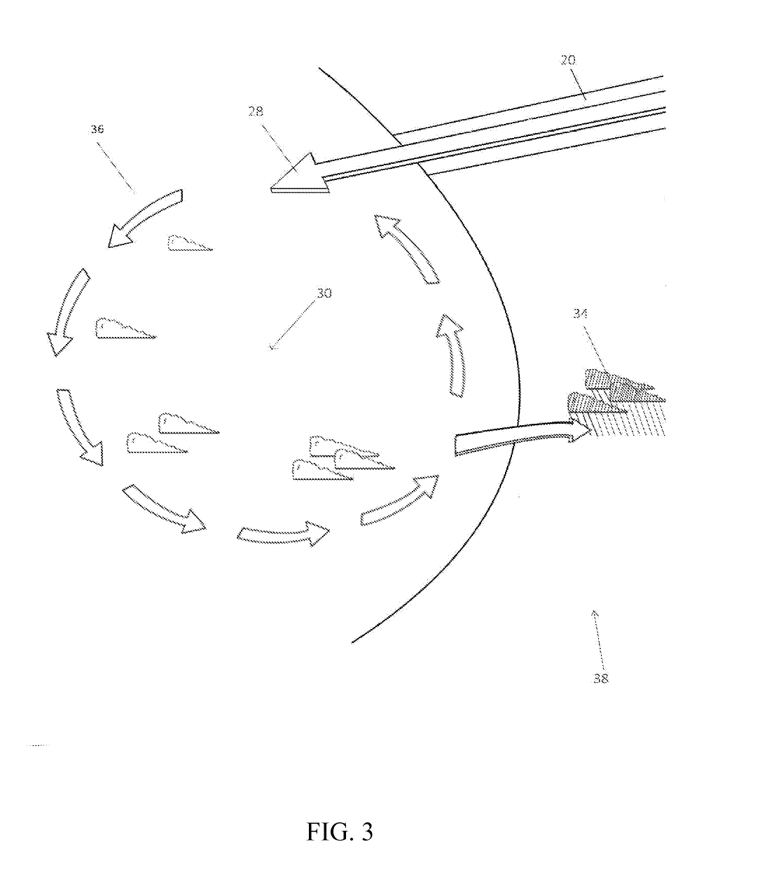

In order to deflect the movement of a large mass of dry air to an oceanic water source the present invention relies on the same principle shown in FIG. 1 in that fluids flow by the path of least resistance. FIG. 2 shows a high altitude view of the present invention referred to as Air Channeler 20. Prevailing dry wind 32 is shown moving across exposed land 16 from left to right. Air Channeler 20 is to be constructed at an angle that is acute to prevailing dry wind 32 and Air Channeler 20 as shown in FIG. 2. The efficiency of Air Channeler 20 is greatest at angles of 15 to 45 degrees as to prevailing dry wind 32 and Air Channeler 20. Air Channeler 20 consists of two members each in the form of a belt. The first being corridor 22 and the second being barrier 24. Corridor 22 is a belt of land that is altered to be as free of wind obstructions as possible so as to encourage the free flow of air along its axis. Width of corridor 22 is large as compared to the width of barrier 24. Barrier 24 is a belt of land that contains a multiplicity of wind turbines arranged in a grid like fashion of varying height and blade length so as to maximize resistance against the normal flow of prevailing dry wind 32. When prevailing dry wind 32 encounters barrier 24 a major portion 28 is deflected onto corridor 22. As corridor 22 provides a path of least resistance and barrier 24 is an obstacle of greater resistance major portion 28 will flow along corridor 22 until corridor 22 terminates at oceanic water source 30. Referring to FIG. 3 major portion 28 will then be taken by oceanic tradewind 36 on a path over oceanic water source 30. While travelling over oceanic water source 30 major portion 28 will readily capture moisture released by the ocean through the evaporative process. As major portion 28 becomes more dense with moisture it will be released by oceanic tradewind 36 towards land 38 where the moisture will be released in the form of rain 34 over land 38.

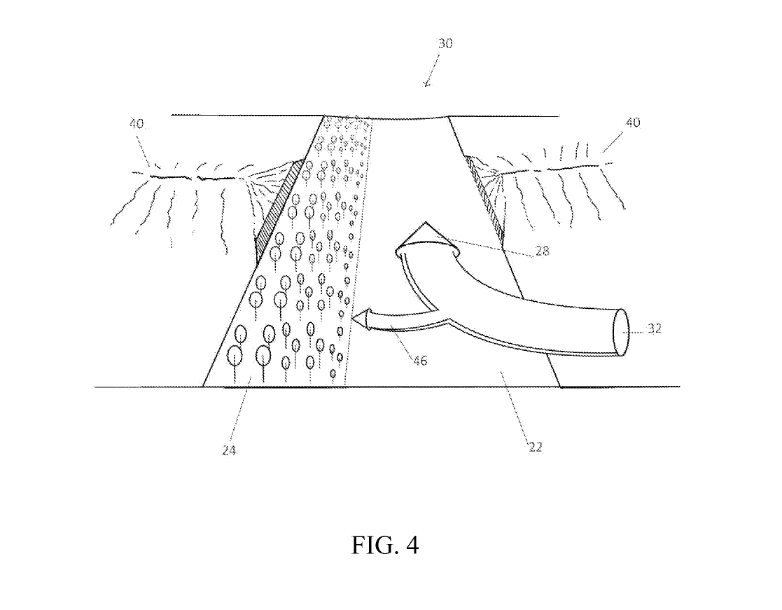

FIG. 4 shows a perspective view of Air Channeler 20. The first member to be encountered by prevailing dry wind 32 is corridor 22. Corridor 22 is to be built at an angle acute to prevailing dry wind 32 as shown in FIG. 4, preferably 15 to 45 degrees. Corridor 22 will also need to be cleared of natural and unnatural obstructions 40 that would resist the flow of air so as to provide a path of least resistance. It is expected that the optimal width of corridor 22 will be in the range of 200 to 400 miles. As prevailing dry wind 32 moves across corridor 22 it will encounter barrier 24 that abuts corridor 22 and is in parallel to corridor 22. When encountering barrier 24 a portion of prevailing dry wind 46 will continue through barrier 24 but major portion 28 will seek a path of least resistance and proceed along the path of least resistance, corridor 22, until reaching the terminus point of Air Channeler 20 at oceanic water source 30. Barrier 24 contains a multiplicity of wind turbines arranged in a grid like fashion of varying height and blade length so as to maximize resistance against the normal flow of prevailing dry wind 32 and to take advantage of existing land obstructions.

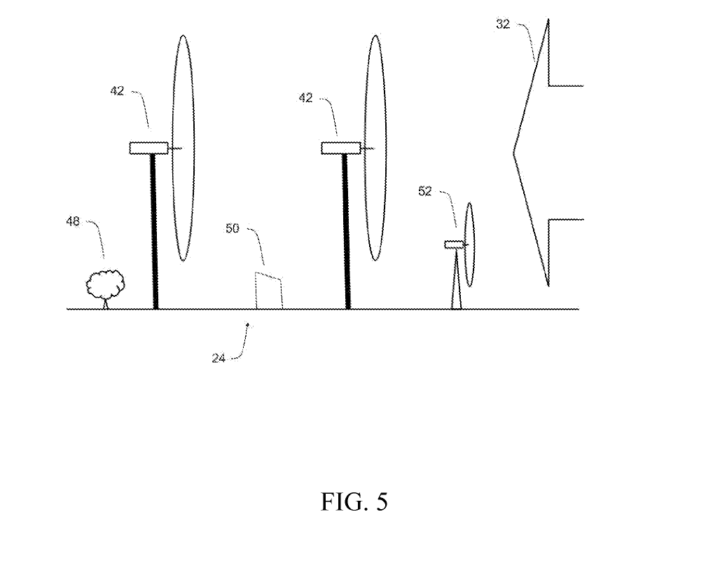

FIG. 5 shows an alternate embodiment of Air Channeler 20. In order to maximize the volume of prevailing dry wind 32 barrier 24 will include interspersed among the wind turbines 42 low lying trees 48, man made air flow impediments such as walls or other smaller devices 50, and smaller wind turbines 52 designed more for resisting air flow rather than power generation. Low lying obstacles 48, 50, and 52 will increase the amount of resistance provided by barrier 24 and will result in a greater portion of prevailing dry wind 32 being channeled into corridor 22.

The scope of this invention as described herein encompasses any obvious alternatives known to those skilled in the art.

I claim:

1. An apparatus for deflecting large masses of air to a particular destination, the apparatus comprising:
a first member consisting of a belt of land that has been cleared of obstacles that may impede the flow of air;
a second member consisting of a belt of land abutting and parallel to said first member containing man made obstacles so as to maximize wind resistance to any oncoming large air mass;
where said first and second members are constructed at an acute angle as to oncoming wind and of a sufficient length to channel the desired amount of air along said first member to a point of terminus.

2. An apparatus for deflecting large masses of air to a particular destination, the apparatus comprising:
a first member consisting of a belt of land that has been cleared of obstacles that may impede the flow of air;
a second member consisting of a belt of land abutting and parallel to said first member containing a matrix of wind turbines of varying sizes so as to maximize wind resistance to any oncoming large air mass;
where said first and second members are constructed at an acute angle as to oncoming wind and of a sufficient length to channel the desired amount of air along said first member to a point of terminus.

3. The apparatus according to claim 2 wherein trees, man made walls, or high air flow resistance wind turbines are interspaced within said second member's matrix of wind turbines.
